(19) United States
(12) Patent Application Publication
(10) Pub. No.: US 2012/0109533 A1
(43) Pub. Date: May 3, 2012

(54) METHOD OF ANALYZING PROTEIN USING DATA-INDEPENDENT ANALYSIS COMBINED WITH DATA-DEPENDENT ANALYSIS

(75) Inventors: Joseph KWON, Jeonju (KR); Chiyoul PARK, Gwangju (KR); Gookpil ROH, Mokpo (KR); Taehoon LEE, Gwangju (KR); Jongsoon CHOI, Daejeon (KR)

(73) Assignee: Korea Basic Science Institute, Daejeon (KR)

(21) Appl. No.: 13/309,038

(22) Filed: Dec. 1, 2011

Related U.S. Application Data
(63) Continuation of application No. PCT/KR2010/002745, filed on Apr. 30, 2010.

(30) Foreign Application Priority Data
Jun. 1, 2009 (KR) 10-2009-48024

(51) Int. Cl. G06F 19/00

(52) U.S. Cl. 702/19

(57) ABSTRACT

The present invention relates to a method of analyzing a protein or proteins comprising the steps of: (A) pre-treating a mixture containing at least one protein to obtain peptides; (B) obtaining information about retention times and mass values of the obtained peptides by performing data-independent analysis; (C) searching a first database on the basis of the information obtained in step (B) to quantify and qualify a target protein or proteins; (D) extracting information about the quantified and qualified target protein or proteins; (E) obtaining information about retention times and mass values by performing data-dependent analysis from the extracted information of step (D); (F) searching a second database on the basis of the information obtained in step (E) to further quantify and qualify the target protein or proteins; and (G) comparing the search results of step (C) and (F) to verify the quantification and qualification.

### CROSS-REFERENCES TO RELATED APPLICATION

This is a continuation of International Application No. PCT/KR2010/002745, with an international filing date of Apr. 30, 2010, which claims the benefit of Korean Application No. 10-2009-48024 filed Jun. 1, 2009, the entire contents of which are incorporated herein by reference.

### BACKGROUND

1. Technical Field

The present disclosure relates, in general, to a method of analyzing a protein using a mass spectrometer, and more particularly to a method of analyzing a protein, which comprises analyzing a protein by data-independent analysis (DIA or MS^{E}) and verifying the analyzed protein by data-dependent analysis (DDA).

2. Related Art

Proteomics is a field of study that aims to identify, characterize, and quantify proteins that are expressed in cells or tissues. Proteomics begin with the rapid development of mass spectrometry after 1990s together with the construction and possible use of a database for the amino acid sequences of proteins.

In comparison with conventional protein biochemistry that has been used to analyze individual proteins, proteomics is very different in terms of the volumes of targets, speeds, the automation of separation means, and the use of genomic/proteomic database information. Because proteomics is a large-scale, multi-stage, high-speed analysis technique that investigates total intracellular protein, it can be applied to investigate the expression, function, structure, and posttranslational modification (PTM) of proteins and protein-protein interactions, and thus it is more complex than genomics and involves a huge amount of data. Proteomics allows the analysis and understanding of the physiological changes, binding properties, and functions of cells. Thus, proteomics can be used to analyze protein isoforms, post-translational modifications such as phosphorylation, binding partners, etc., which cannot be found based on genetic information alone, and thus it can be used to analyze the mechanism of development of diseases and diagnose or treat diseases.

Generally, in proteomics, a protein mixture isolated from cells is digested by a specific method to make peptides, which are then subjected to mass spectrometry to obtain the mass spectrum information of the peptides, and the mass spectrum information is compared with an existing database, thereby quantitatively and qualitatively analyzing the protein. In other words, using data obtained from mass spectrometry and the protein sequences registered in databanks (NCBI, EXPASY, ETS, etc.), predicted data are compared and examined through a hypothetical fragmentation, thereby identifying proteins present in the sample. This proteomics is very useful, because gene information can be obtained by searching a genome and gene sequence database, and the amount of protein information registered in databanks is increasing in a geometrical progression.

A mass spectrometer is called in various names according to an ionization source and a mass analyzer (detector). Methods that are typically used to ionize sample proteins or peptides include electrospray ionization (ESI) and matrix-assists laser desorption ionization (MALDI). ESI is a method of ionizing liquid samples and is easily directly connected with a liquid chromatography separation method. MALDI comprises mixing a matrix with a sample, drying the mixture to form a crystal and ionizing the crystal by a laser.

Mass analyzers that are currently widely used include a ion trap analyzer, a time-of-flight (TOF) analyzer, a quadrupole (Q) analyzer and a fourier transform ion cyclotron resonance (FT-ICR) analyzer, which are used alone or in a combination of two or more thereof (tandem mass spectrometer).

Among tandem mass spectrometers, a triple-quadrupole mass spectrometer consists of three quadrupole analyzers (Q₁, Q₂ and Q₃) connected in tandem. In the central quadrupole analyzer (Q₂), injected neutral gas collides with sample ions to fragment the ions. The tripe-quadrupole analyzer is operated in two modes: a scan mode and a fragmentation mode. In the scan mode, only the Q₁ analyzer is operated so that ions of all m/z values are recorded, and it is possible to perform the mass analysis of all ions within 1 sec. In the fragmentation mode, Q₁, Q₂ and Q₃ are all used. In Q₁(mass filter), voltage applied to the quadrupole is controlled (filtered) such that only ions having a predetermined m/z value (or range) are passed through Q₁, and the passed ions enter a collision chamber (Q₂). The ions that entered the collision chamber are fragmented by collision with argon gas. The fragmented ions enter Q₃ and they are separated by mass-to-charge ratio and the results are recorded in the detector.

A data-dependent analysis (DDA) method is carried out using this tripe-quadrupole analyzer. The DDA method comprises obtaining mass-to-charge (m/z) values for all peptide ions in a sample in a scan mode, fragmenting the peptide in a fragmentation mode (MS/MS), and obtaining mass-to-charge (m/z) for the pigmented ions. Herein, MS and MS/MS are crossed to produce data (spectra).

The DDA method has an advantage in that, if accurate information about retention time and mass value (m/z) is input, only a substance in a sample, corresponding to the input information, can be analyzed. However, it has a disadvantage in that substances having large peptide ions are likely to be analyzed, and thus a small amount of a peptide may not be analyzed because it is not fragmented.

In recent years, as a methodology for obtaining peptide information, which has a concept different from the DDA method, a data-independent analysis method (high/low collision energy MS; MS^{E}) has been proposed in which high collision energy and low collision energy are applied at the same time. This MS^{E} method is also carried out using the triple-quadrupole analyzer. The MS^{E} method comprises causing all peptides passed in unit time to collide with collision gas so as to be fragmented, and combining the information about the mixed peptide fragments with retention time in liquid chromatography and the patterns of obtained mass values, thereby producing MS/MS spectral information to be used for analysis.

This MS^{E} method is more advantageous for analysis of a relatively small amount of a peptide than the DDA method, because it produces peptide fragments without regard to the observed height of ions. However, the MS^{E} method has shortcomings in that proteins can be analyzed only by Proteinlynx Global Server (PLGS) of Waters Inc. and in that the method is not suitable for MASCOT and the like which are most frequently used by researchers. However, the MS^{E} method has a powerful advantage in that it can analyze even a protein that is present in a trace amount in a sample. For example, it is thought that 23 kinds of proteins account for 98% of blood protein, and biomarkers of interest are present in the remaining 2%. In order to analyze these trace proteins, a process of removing a large amount of proteins to concentrate the trace proteins is required. However, blood samples cannot be obtained in large amounts, and thus there is a limit to the concentration of the blood samples. Also, membrane proteins are contaminated with intracellular proteins present in large amounts, which interfere with analysis of the membrane proteins. Despite the development of various methods, the analysis and verification of trace proteins (and membrane proteins) are difficult to perform.

There is thus a need for a new method of analyzing a protein.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention aims to provide a method of using the MS^{E} and DDA methods in a new way that can analyze and verify chemical changes in trace proteins. For example, as shown in FIG. 1, the present invention aims to provide a method of analyzing a protein by data-independent analysis (MS^{E}) and verifying the analysis result by data-dependent analysis (DDA), which can verify more reliable information about a protein by giving optimal minimal information from MS^{E} to DDA. By the method, a modified protein can be detected and analyzed rapidly and easily using a mass spectrometer. Also, a trace protein present in a sample can be detected and identified rapidly and easily using protein database information and a mass spectrometer. Further, information about chemical modification of proteins of industrial and scientific importance, that is, post-translational modification (PTM) of proteins, which are important for cell signaling studies, drug development, etc., can be obtained in a rapid and effective manner.

In one aspect, the present invention provides a method of quantification and qualification of a protein(s), the method comprising the steps of: (A) pre-treating at least one protein or a mixture containing at least one protein to obtain peptides; (B) obtaining information about retention times and mass values of the obtained peptides by performing data-independent analysis using a liquid chromatography-mass spectrometer (LC-MS); (C) searching a first database (e.g., PLGS) on the basis of the information obtained in step (B) to quantify and qualify a target protein or proteins; (D) extracting information about the quantified and qualified target protein or proteins; (E) obtaining information about retention times and mass values by performing data-dependent analysis using an LC-MS from the extracted information of step (D); (F) searching a second database (e.g., MASCOT) on the basis of the information obtained in step (E) to further quantify and qualify the target protein or proteins; and (G) comparing the search results of steps (C) and (F) to verify the quantification and qualification.

This invention may comprise an additional step of selecting a protein or a protein group of interest with reference to a protein database before the step (C). In this case, preferably, as the database in step (C), a database allowing for time-efficient analysis may be used.

In still another aspect, the present invention provides a program for performing said methods for quantitatively and qualitatively analyzing a protein and a storage medium storing the program.

In the present invention, the mass spectrometer may, preferably, be a triple-quadrupole mass spectrometer.

In the present invention, the protein may be a trace protein present in a cell, for example, a membrane protein. Also, the protein may be a post-translational modified (PTM) protein, for example, a cysteine-containing protein.

The above and other aspects and features will be further described.

### BRIEF DESCRIPTION OF THE DRAWINGS

FIG. 1 is a flow chart showing a process of identifying and verifying a protein according to the present invention.

FIG. 2A is a program image showing the application of “include list” obtained by extracting information about cysteine-containing peptides according to a method of the present invention, and FIG. 2B is a diagram showing a distribution of peptides in the extracted “include list”.

FIG. 3 is a diagram showing the results of applying “include list” to a DDA mode and performing total ion chromatography (TIC) in an embodiment of the present invention.

FIG. 4 is a diagram showing a comparison between the number of proteins searched according the present invention and the number of proteins searched by a prior art method.

FIG. 5 is a diagram showing a distribution of membrane proteins in “include list” for membrane proteins in an embodiment of the present invention.

FIG. 6 is a diagram showing a comparison between information about membrane proteins analyzed in an embodiment of the present invention and information about membrane proteins analyzed according to a prior art method.

FIG. 7 is a diagram showing a difference in peptide information used in the present MS^{E}-DDA method and a DDA method with respect to a specific protein (Slr0906).

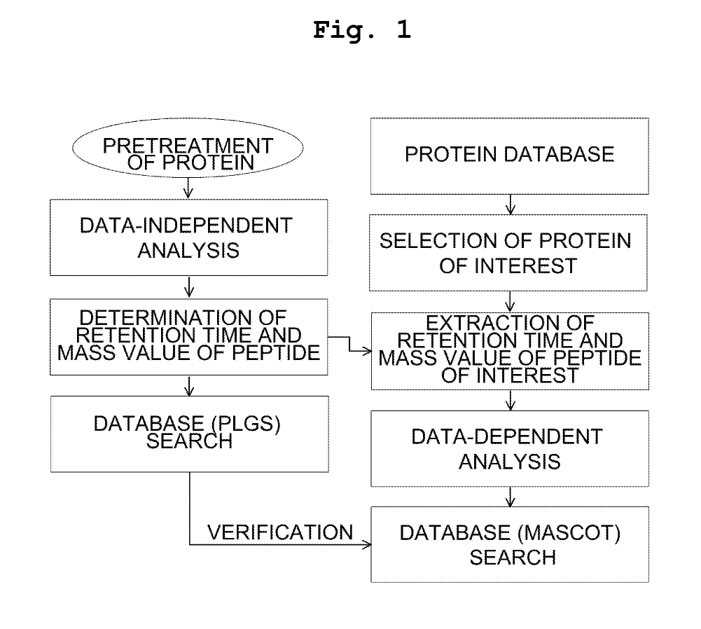

### DETAILED DESCRIPTION OF EMBODIMENTS

Hereinafter, the present invention will be described in further detail with reference to examples. However, these examples are intended to illustrate rather than limit the technical idea and scope of the present invention. It will be obvious to those skilled in the art that various modifications are possible within the scope of the technical idea of the present invention.

The term “include list” used herein is defined as a list including information about a particular set of retention times and mass values of peptides obtained from at least one protein or a mixture containing at least one protein, and this information will be used in a DDA mode to analyze a target protein or proteins.

From information obtained by MS^{E} analysis of proteins, the retention times and mass values of peptides that have been used to analyze the target protein or proteins were taken and a program capable of easily making “include list” was constructed. “Include list” to be used in verification will vary depending on the meaning imparted to proteins obtained from MS^{E} analysis. As such, a proper include list can be constructed according to a target protein or proteins. For example, as described below, if a target protein is a cysteine-containing protein or a membrane protein, a proper include list tailored to the target protein can be constructed.

### EXAMPLES

The following examples illustrate the invention and are not intended to limit the same.

### Example 1

### Analysis of Specific Chemical Change in Cysteine

If a test to be carried out is a test for observing a specific chemical change in the amino acid cysteine, proteins containing cysteine can be selected from protein information obtained from MS^{E}, and peptide information that have been used to analyze the proteins can be collected, thus producing “include list”.

(1) Protein Pretreatment

Many proteins have an S-S covalent bond between cysteine residues. Under specific conditions, i.e., pathogenic conditions, the S—S bond breaks. To confirm this, a protein was covalently bonded with two chemical substances to make a sample. When the sample was treated with iodoacetamide, there was a change in mass of +57.02 Da in cysteine, and when the sample was treated with N-ethyl maleimide (NEM), there was a change in mass of +111.03 Da in cysteine.

After being treated with iodoacetamide, the protein sample was treated with DTT (dithiothreitol) to break the S—S bond. Then, the protein sample was treated with NEM, whereby a protein in which the S—S bond was originally broken could be distinguished from a protein in which the S—S bond was not originally broken.

(2) Data-Independent Analysis and Database Search

The sample was analyzed in a nano-HPLC-MS^{E} mode composed of Nano-HPLC connected with Synapt HDMS tandem mass spectrometry (Waters). The analysis was performed in the following conditions:

| | |
|---|---|
| Column | 75 μm (inner diameter) × 25 cm |
| | 10 min gradient |
| Final flow rate and pressure | 350 nL/min and 8,000 psi |
| Ramping conditions | Low collision energy: 4 eV |
| | High collision energy: 15-40 eV |

To correct mass value, 200 fmol/μl glu-fibrino peptide (785.8426 Da [M + 2H]²⁺) was used at a rate of 500 nL/min at 30-sec intervals.

The test was performed three times. The raw data obtained from the test was processed in PLGS to search proteins using the sprot database in an automatic mode with peptide tolerance and fragmentation tolerances.

(3) Preparation of EMRT Table and Determination of “Include List”

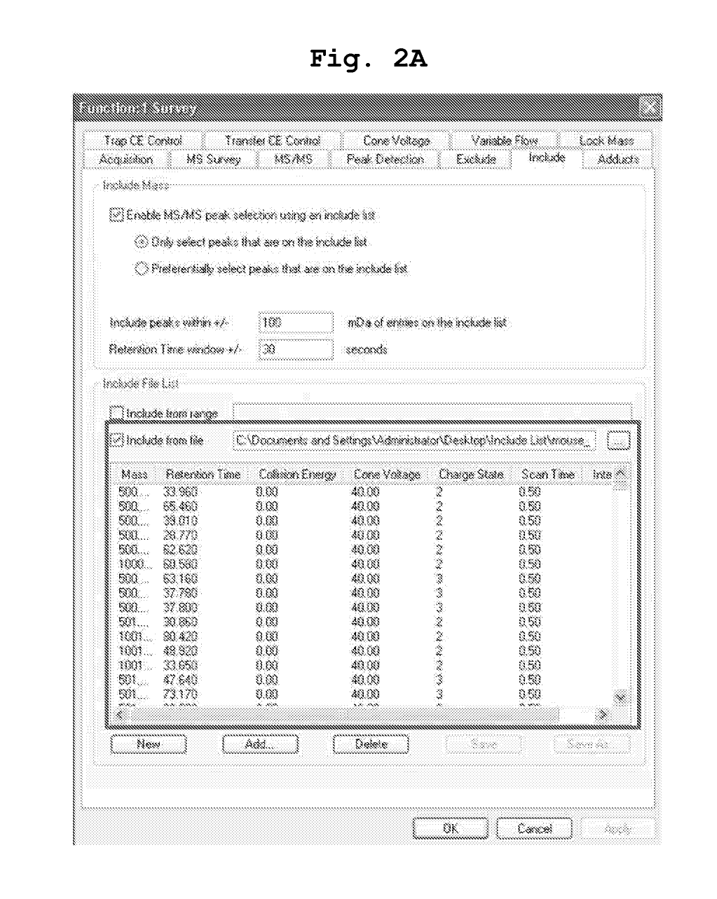

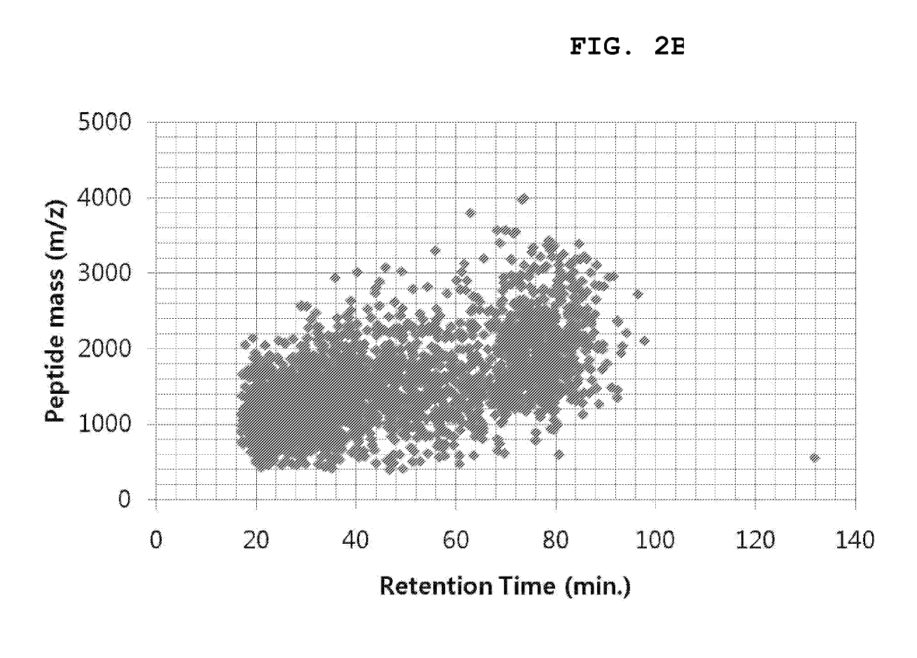

Among EMRT information produced by the MS^{E} test, retention times and mono isotope mass of peptides for proteins containing cysteine were calculated to prepare “include list” (see FIG. 2).

(4) Data-Dependent Analysis

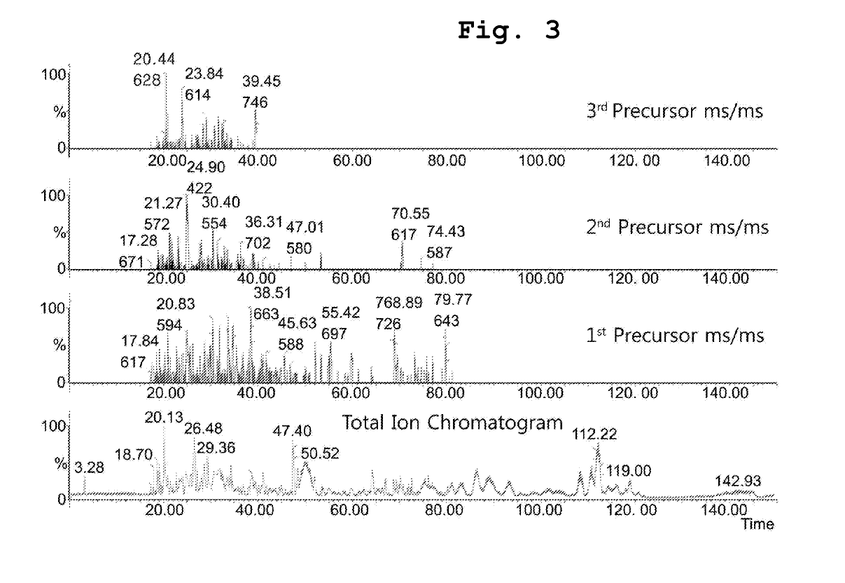

The “include list” was applied to the DDA mode to obtain the results of total ion chromatography (TIC) as shown in FIG. 3. The LC developing solvent and flow rate used in the DDA test were the same as those used in the data-independent test. 5 μl of each of the samples was injected through an autosampler, and desalted and concentrated in a C18 trapping column. As an internal standard, 100 fmol/ml glu-fibrino peptide B was injected at a rate of 600 nL/min and ionized. Mass spectrometry was programmed such that a region of m/z 50-1990 was scanned in the V mode and a maximum of 3 precursor ions were fragmented.

In FIG. 3, the first to third graphs show the results of fragmenting ions corresponding to the selected mass values present in the “include list”, and the fourth graph showing the results of treatment (TIC chromatography) performed for 150 minutes.

(5) Database Search (Verification)

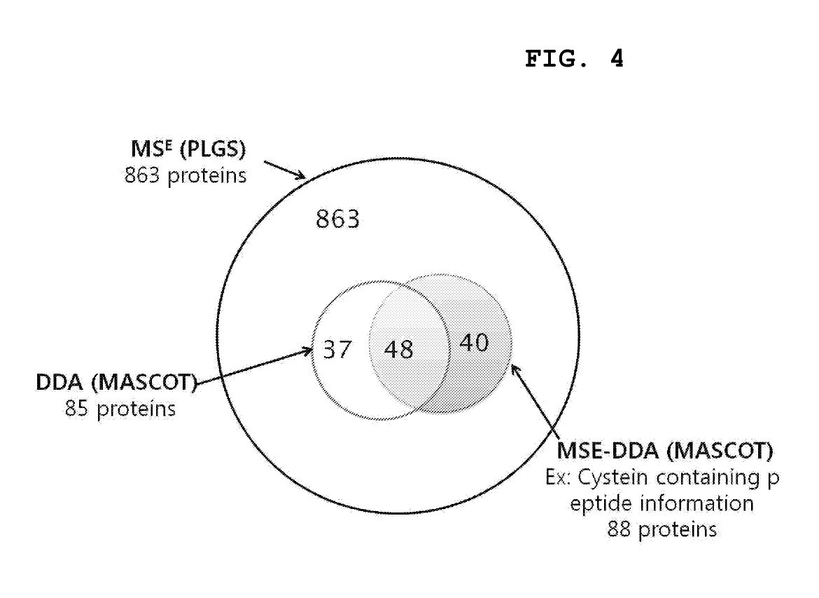

Search was performed in the protein database IPI_mouse_v3.44.fasta using the MASCOT v 2.2 program. The search was performed using carbamidomethylation (C) and N-ethylmaleimide as variable modification at a peptide tolerance of 100 ppm and a ms/ms tolerance of 0.2 Da (FIG. 4).

In FIG. 4, the MS^{E} results were analyzed by PLGS, and the MS^{E}-DDA and DDA results were searched using MASCOT. As can be seen in FIG. 4, when information about the cysteine-containing proteins among the proteins searched by the MS^{E} method was extracted and analyzed, 88 proteins could be found, and such results significantly differed from the results obtained when analysis was performed by the DDA mode alone. Also, N-ethyl maleimide that chemically labeled the cysteine targeted in the present invention was found with a high score, indicating that it can be sufficiently used for specific PTM analysis. The EMRT table obtained in the MS^{E} analysis is reliable, suggesting that the automatic production of “include list” based on this information is effectively performed.

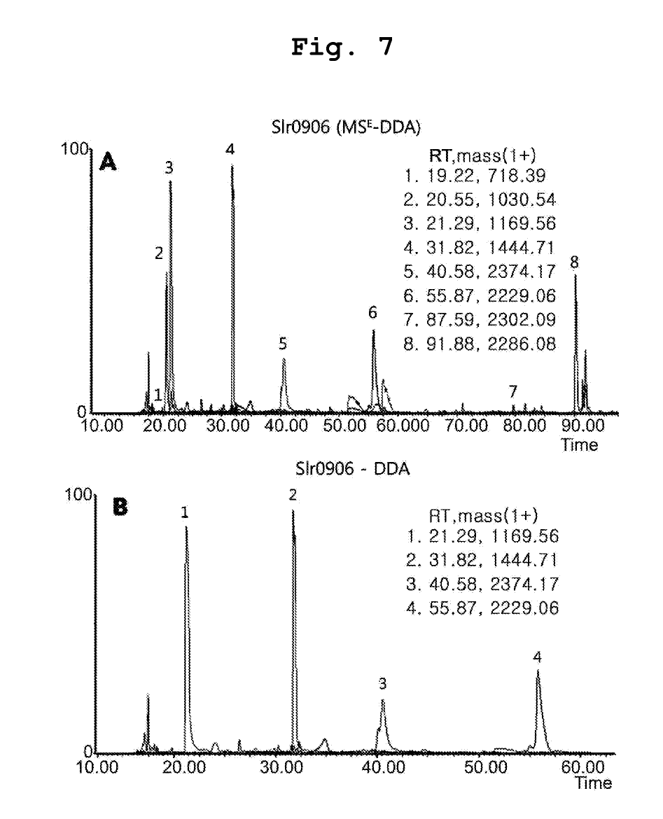

As can be seen in FIG. 7, when data-dependent analysis (MS^{E}-DDA) was carried out using accurate information, proteins including information about the modification of 40 cysteines that could not be analyzed in the DDA mode alone could be found.

In this Example, information obtained from data-independent analysis was used to verify trace proteins, and the method of this Example can provide a good method capable of more accurately obtaining information about the chemical modification of proteins.

### Example 2

### Analysis and Verification of Membrane Proteins

Analyzing membrane proteins of industrial and scientific importance using a mass spectrometer is difficult due to their relatively small amounts. Accordingly, in the present invention, membrane proteins present in relatively small amounts were analyzed by the data-independent analysis method, and only information about the membrane proteins was extracted such that the membrane proteins could be analyzed by data-dependent analysis, whereby the membrane proteins could be analyzed and verified with higher reliability.

If proteins to be analyzed are membrane proteins, it is possible to use a method comprising predicting membrane proteins using a protein database and then producing an “include list” in comparison with the list of the predicted membrane proteins. From this Example, it can be seen that the present invention can be applied to analyze a mixture of proteins present in relatively small amounts.

(1) Database Search and Prediction of Membrane Proteins

The Synechocytosis protein database includes information about a total of 3661 proteins. From this protein information, information about a total of 706 membrane proteins was extracted using TMHMM 2.0 (http://www.cbs.dtu.dk/services/TMHMM/) and Signal P 3.0 (http://www.cbs.dtu.dk/services/SignalP/).

The extracted information about the membrane proteins were stored in the form of a text file as follows.

slr1405, slr1456, slr1708, sll1942, slr2013, slr2010, sll0002,
sll1021, ssr2422, sll1158, sll1155, slr0533, slr1895, slr0678,
slr2003, sml0005, slr2016, ssr0550, ssl6077, slr1187, sll0498,
ssr3307 . . . the rest is omitted.

(2) Data-Independent Analysis and Database Search

A sample was analyzed in a nano-HPLC-MS^{E} mode composed of Nano-HPLC connected with Synapt HDMS tandem mass spectrometry (Waters). The analysis was performed under the following conditions:

| | |
|---|---|
| Column | 75 μm (inner diameter) × 25 cm |
| | 10 min gradient |
| Final flow rate and pressure | 350 nL/min and 8,000 psi |
| Ramping conditions | Low collision energy: 4 eV |
| | High collision energy: 15-40 eV |

To correct mass value, 200 fmol/μl glu-fibrino peptide (785.8426 Da [M + 2H]²⁺) was used at a rate of 500 nL/min at 30-sec intervals.

The test was performed three times. The resulting raw data including information about peptide fragments were processed in PLGS to search proteins using the sprot database. The proteins were searched under the following conditions: fragment tolerance: 100 ppm, MS/MS tolerance: 0.1 Da, enzyme: trypsin, missed cleavages: 1, fixed modification: cabamidomethylation (C), variable modification: oxidation (M).

(3) Preparation of EMRT Table and Determination of “Include List”

In order to analyze membrane proteins of interest by comparing gene indices predicted as the membrane proteins with independent data (EMRT table), the retention times and mono isotope mass of the peptides and their orders used were extracted to produce an “include list” such that data-dependent analysis could be performed.

A program for automatic production of the “include list” is illustrated below.

<Example of Program for Production of “Include List”>

#!/usr/bin/perl
use strict;
use warnings;
use Getopt::Long;
my $usage = “$0 -i inputfile -o outputfile -e parameter[0|1] [symbol] n”;
my ($inputfile, $listfile, $outfile, $param);
GetOptions(‘i=s’=> [symbol] $inputfile, ‘l=s’=> [symbol] $listfile, ‘o=s’=> [symbol] $outfile);
die “ [symbol] n$usage” if ( not defined $inputfile or not defined $outfile or not
defined $listfile);
die “ [symbol] nCheck files [symbol] n” if ( not -e $inputfile or not -e $listfile);
my @list;
open FILE, $listfile;
for (<FILE>) {

chomp;
push @list, $_;

}
close FILE;
open OFILE, “>$outfile”;
print OFILE “Mass,RT(second),charge [symbol] n”;
open FILE, $inputfile;
my $tmp = <FILE>;
for ( <FILE> ) {

chomp;
my @a = split /,/, $_;
foreach my $pro ( @list ) {

if ( $a[5] =~ /$pro/ ) {

print OFILE “$a[2],”,$a[3]*60,“,1 [symbol] n”;
print OFILE ($a[2]+1.0078)/2,“,”,$a[3]*60,“,2 [symbol] n”;
print OFILE ($a[2]+2*1.0078)/3,“,”,$a[3]*60,“,3 [symbol] n”;
last;

}

}

}
close FILE;
close OFILE;

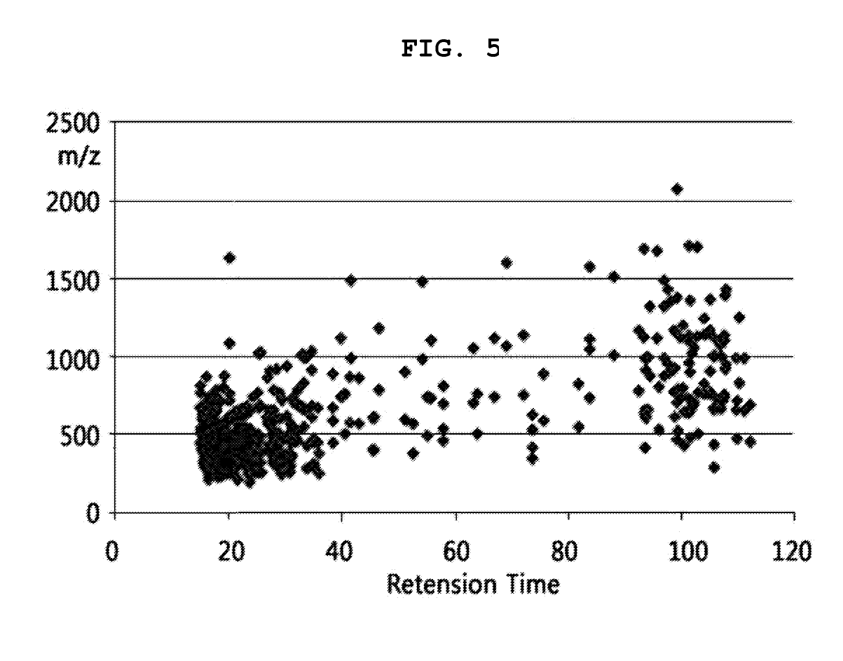

Using the above-prepared program, an “include list” having a peptide distribution as shown in FIG. 5 was extracted. FIG. 5 shows the extracted distribution and is practically used in the form of a test file. In FIG. 5, the x-axis indicates the retention times of peptides in the analysis column, and the y-axis indicates the mass values of peptides. The points on the graph of FIG. 5 indicate the retention times and mass values of the peptides derived from membrane proteins.

(4) Data-Dependent Analysis

Data-dependent analysis was performed under the following conditions:

| | |
|---|---|
| Column | 75 μm (inner diameter) × 25 cm |
| | 10 min gradient |
| Final flow rate and pressure | 350 nL/min and 8,000 psi |
| Ramping conditions | Low collision energy: 4 eV |
| | High collision energy: 15-40 eV |

To correct mass value, 200 fmol/μl glu-fibrino peptide (785.8426 Da [M + 2H]²⁺) was used at a rate of 500 nL/min at 30-sec intervals.

The LC developing solvent and flow rate used in the data-dependent test were the same as those used in the data-independent test. 5 μl of each of the samples was injected through an autosampler, and desalted and concentrated in a C18 trapping column. As an internal standard, 100 fmol/ml glu-fibrino peptide B was injected at a rate of 600 nL/min and ionized. Mass spectrometry was programmed such that a region of m/z 50-1990 was scanned in the V mode and a maximum of 3 precursor ions were fragmented.

(5) Database Search (Verification)

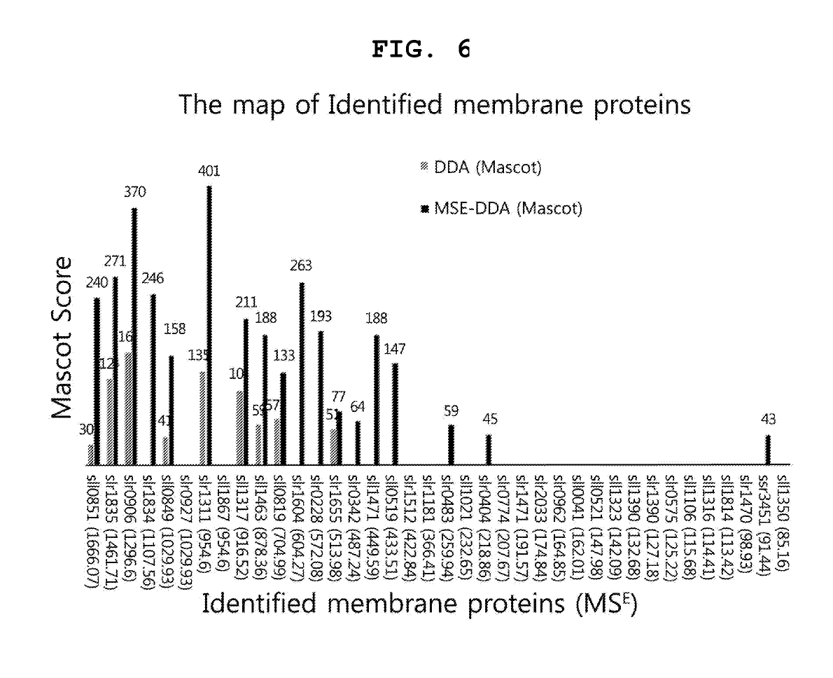

Membrane proteins were analyzed by both the method according to the present invention (MS^{E}-DDA analysis method) and the prior art methods (MS^{E} and DDA analysis methods) (FIG. 6). In FIG. 6, the x-axis indicates membrane protein information analyzed by the data-independent analysis method, the black bar graphs indicate the results of data-dependent analysis performed using the information about the “include list”, and the red bar graphs indicate the results of data-dependent analysis performed without the “include list” information.

As can be seen from the graphs in FIG. 6, the MS^{E}-DDA analysis method showed data scores which were at least two times higher than those of the data-dependent analysis (DDA) method. This is because peptide information was given at more accurate timing, and thus the MS^{E}-DDA analysis method was performed without quantitative loss. In addition, the number of the proteins analyzed was greater in the MS^{E}-DDA method than in the DDA method.

It was found that proteins, which were analyzed in the MS^{E} method (x-axis), but not analyzed in the MS^{E}-DDA method, were distributed in small amounts. It is considered that the reliability of analysis by the MS^{E} method is lower because there is no or less accurate information about peptide analysis.

As a specific example, FIG. 7 shows how peptide information is recognized in the MS^{E}-DDA method and the DDA method in order to find the protein Slr0906 (galactose mutarotase and related enzymes).

FIG. 7A shows information about 8 peptides obtained by the MS^{E}-DDA analysis method and depicts the results of SIC (selected ion chromatography) of the corresponding peptides. FIG. 7B shows information about four peptides resulting from the DDA method performed to analyze the same protein used in the MS^{E}-DDA method. The reason why the number of peptides differs between the DDA method and the MS^{E}-DDA method is because the DDA analysis method is not based on the results of data-independent analysis.

As described above, according to the present invention, the results analyzed by the existing data-independent analysis method are compared with pre-calculated biological information to obtain information about peptides to be analyzed. Also, the obtained information is substituted into a data-dependent analysis mode to produce desired peptide fragments that can be used to analyze and verify a protein.

According to the MS^{E}-DDA analysis methods, more accurate peptide information is used so that more peptide information is used to analyze a specific protein. Thus, an increase in the score of protein can be seen. Because higher scores of protein indicate the higher reliabilities of analysis of the protein, verification of protein by the MS^{E}-DDA method can be useful. According to the methods, a modified protein and a trace protein present in a sample can be easily detected and quantitatively and qualitatively analyzed. Thus, the present invention is very useful in cell signaling studies, drug development, etc.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A method of quantification and qualification of a protein or proteins, the method comprising steps of:
(A) pre-treating at least one protein or a mixture containing at least one protein to obtain peptides;
(B) obtaining information about retention times and mass values of the peptides by performing data-independent analysis using a liquid chromatography-mass spectrometer (LC-MS);
(C) searching a first database on the basis of the information obtained in step (B) to quantify and qualify a target protein or proteins;
(D) extracting information about the quantified and qualified target protein or proteins;
(E) obtaining information about retention times and mass values by performing data-dependent analysis using an LC-MS from the extracted information of step (D);
(F) searching a second database on the basis of the information obtained in step (E) to further quantify and qualify the target protein or proteins; and
(G) comparatively analyzing the search result of step (C) and the search result of step (F) to verify the quantification and qualification.

2. The method of claim 1, wherein the mass spectrometer is a triple-quadrupole mass spectrometer.

3. The method of claim 1, wherein the protein is a trace protein present in a cell.

4. The method of claim 3, wherein the protein is a membrane protein.

5. The method of claim 1, wherein the protein is a post-translationally modified (PTM) protein.

6. The method of claim 5, wherein the protein is a cysteine-containing protein.

7. The method of claim 1, where in the first database is PLGS and the second database is MASCOT

8. The method of claim 1 comprising additional step of selecting proteins group of interest with reference to a protein data base before step (C).

9. A storage medium storing a program for performing the method of claim 1.
